(19) United States
(12) Patent Application Publication
(10) Pub. No.: US 2005/0149874 A1
(43) Pub. Date: Jul. 7, 2005

(54) Internet terminal, WWW-browser located in the terminal and a method for setting a display mode of the terminal

(75) Inventors: Petri Kokko, Oulu (FI); Michael Klingele, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/001,886

(22) Filed: Dec. 1, 2004

(30) Foreign Application Priority Data
Dec. 11, 2003 (WO) PCT/FI03/00947

(51) Int. Cl. G06F 3/00

(52) U.S. Cl. 715/746; 715/781

(57) ABSTRACT

The invention relates to an Internet terminal with means for establishing a connection to the Internet via a mobile communications network. The device has a processor, a display, information input means and a memory for loading files and application programs. At least an operating system and a web browser according to the invention have been loaded into the memory. The browser program includes means for switching the display to two different display modes. The content area reserved for reproducing web pages and at least one task bar are visible on the display in the first display mode, and only the content area, which fills up essentially the whole display, is visible on the display in the second display mode. The means mentioned in the invention for setting the display comprise a graphical element permanently placed in the content area, into which graphical element the display mode switching operation has been integrated. The graphical element is made to change its appearance in a way that it has a first appearance when the display is in the first display mode, a second appearance when the display is in the second display mode, and a third appearance when the loading of web pages is in progress. In addition, the third appearance of the graphical element contains a verbal or pictorial indication that the loading of web pages is in progress, and an indication of the stage of the web page loading process.

The invention relates to an Internet terminal with means for establishing a connection to the Internet by means of a mobile communications network, a processor, a display, data input means and a memory into which at least an operating system and a web browser have been loaded, the web browser including means for switching the display to a first display mode or to a second display mode in a way that the size of the content area reserved for reproducing the web pages is substantially larger in the second display mode than in the first display mode. The invention also relates to a web browser located in the Internet terminal and a method for setting a display mode of the Internet terminal.

The Internet is an important channel for presenting and distributing knowledge and information. The material in the Internet is presented on the web pages, which can be read with a terminal device connected to the Internet, such as a personal computer. The content of the pages is nowadays often of the multimedia type, i.e. many different ways of presenting information are combined on the page, such as text, images, animations, sound, live video image and hypertext links to other web pages. The programming language used on the Internet pages is generally HTML (Hypertext Markup Language).

For reading the Internet pages, the user's terminal must have a browser which can reproduce the content of the pages downloaded from the Internet on the display of the terminal. Generally, the view produced on the display of the terminal by the browsers is such that the actual content of the downloaded Internet pages is presented in a content area located in the centre of the display. In addition to this, the browser generally produces a header bar on the upper part of the display, and a task bar below it with a separate menu part and an icon part. Below the task bar there is an address line and on the edge of the display a vertical scroll bar. By means of the menus and icons of the task bar, the user can control the operation of the browser.

The traditional web browsers have been developed primarily for personal computers which are connected to the Internet via a wired data transfer connection. Such computers generally have a relatively large display, and thus the size of the content area formed on the display is usually sufficient for presenting web pages. Nowadays an increasing number of the mobile terminals on the market, such as mobile phones and palm computers, are equipped with Internet capabilities. Due to mobile terminals and wireless data transfer, users have access to the Internet regardless of their location. However, the use of mobile terminals as Internet terminals also entails some problems. There is a tendency of making mobile terminals as small as possible so that carrying them along would be as easy and user-friendly as possible. Because of the small size of the terminal it has a relatively small display, and the header bar, task bar, address line and scroll bar produced on the display by the browser further reduce the size of the content area intended for presenting web pages. For this reason, presenting web pages designed for larger displays on the display of a mobile terminal is often cumbersome. An attempt has been made to increase the size of the content area by developing web browsers especially designed for mobile terminals; in these browsers the display area required by the header bar, task bar, address line and scroll bar has been minimised by relocating and combining the operations. The purpose of this is to make the size of the content area as large as possible.

The browsers are also equipped with a possibility to switch the program to a display mode in which the header bar, task bar and address line have been entirely removed from the display. Then the content area intended for presenting web pages essentially fills up the entire display of the terminal. However, switching from “normal display” to “entire display” requires that the user selects many consecutive operations from the menus of the browser. Changing display modes is therefore complicated and requires that the user has a thorough knowledge of the operations and properties of the browser. The difficulty of the operation is further increased by the fact that the display mode must be returned to normal every time when moving to a new web page in order to control the operations of the browser.

Maximum utilization of the size of the display in a terminal thus requires for the user to switch repeatedly between different display modes, which is cumbersome and time-consuming.

The purpose of the invention is to provide an Internet terminal, a web browser in the Internet terminal and a method for setting a display mode of the Internet terminal, whereby the disadvantages of the prior art terminals and browsers can be reduced.

The objectives of the invention are achieved with a terminal, a web browser and a method, the characteristic features of which are presented in the independent claims. Some preferred embodiments of the invention are presented in the dependent claims.

The invention relates to an Internet terminal with means for establishing a connection to the Internet by means of a mobile communications network. The terminal is preferably built so small and light that the user can easily carry it along. The terminal has a processor, a display, information input means and a memory for loading files and application programs. The display of the terminal is preferably a so-called touch-screen display, but the display can also be a conventional display used in terminals. Loaded into the memory there is at least an operating system and a web browser according to the invention, which can reproduce the content of the web pages downloaded from the Internet on the display of the terminal. The browser comprises means for switching the display to at least two different display modes, in which the content areas reserved for reproducing web pages are clearly of different size, i.e. in the second display mode the size of the content area is substantially larger than in the first display mode. The means for setting the display modes according to the invention comprise a graphical element permanently placed on the content area. The display mode switching operation has been integrated into the graphical element in a way that selecting the graphical element causes the display mode to change.

In an advantageous embodiment of the invention, the content area and at least one task bar are shown on the display in the first display mode, and only the content area, which fills up essentially the whole display, is shown on the display in the second display mode.

In another advantageous embodiment of the invention, the graphical element is made to change its appearance in a way that it has a first appearance when the display is in the first display mode, a second appearance when the display is in the second display mode and a third appearance when the loading of web pages is in progress, in which case the first, the second and the third appearance are essentially different. The graphical element is preferably located in the upper right corner of the content area.

In a third advantageous embodiment, the third appearance of the graphical element contains a verbal or pictorial indication that downloading web pages is in progress and an indication of the stage of the downloading process.

The invention has the advantage that it significantly increases the comfort of use of an Internet terminal equipped with a small-sized display.

In addition, the invention has the advantage that browsing the web pages in the terminal becomes faster, whereby the required Internet connection time is shortened. This provides savings in communication costs.

In the following, the invention will be described in more detail. Reference will be made to the accompanying drawings, in which

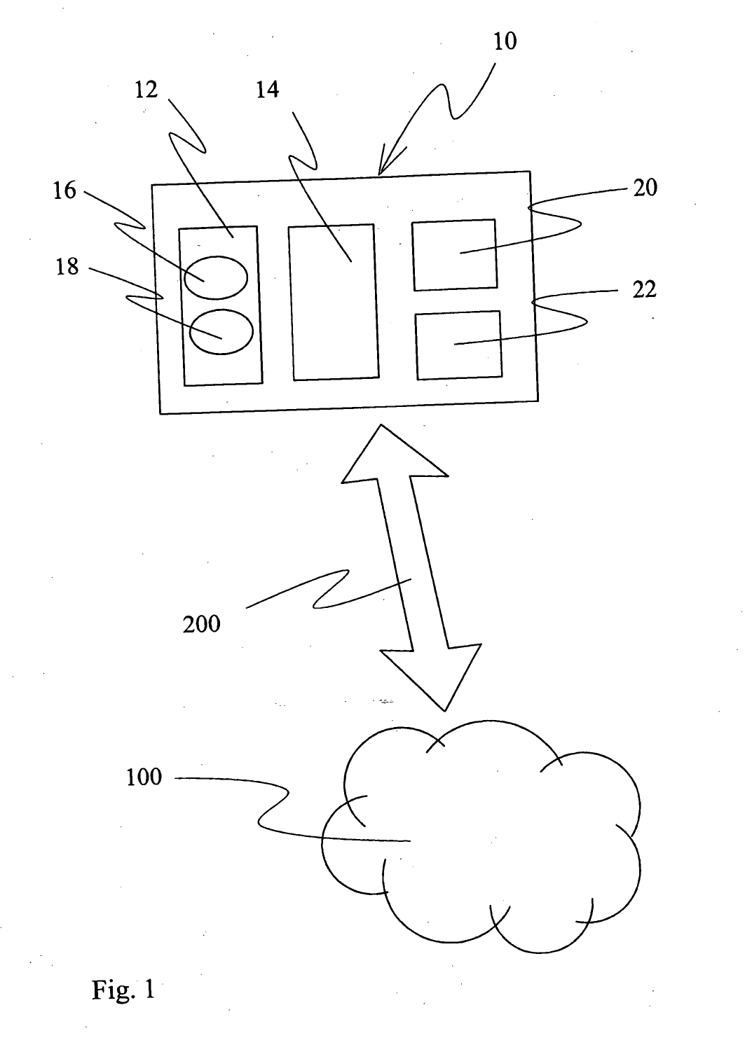

FIG. 1 illustrates the structure of a mobile Internet terminal according to the invention as a block diagram,

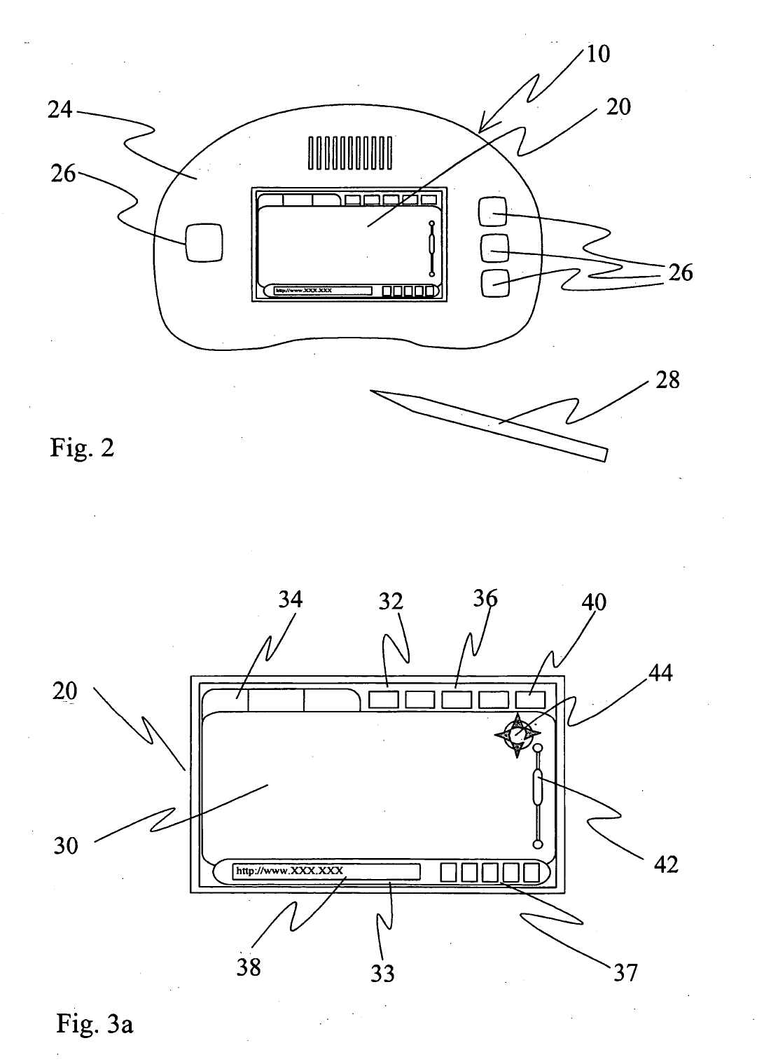

FIG. 2 illustrates an example of a mobile Internet terminal according to the invention as viewed from the front, and

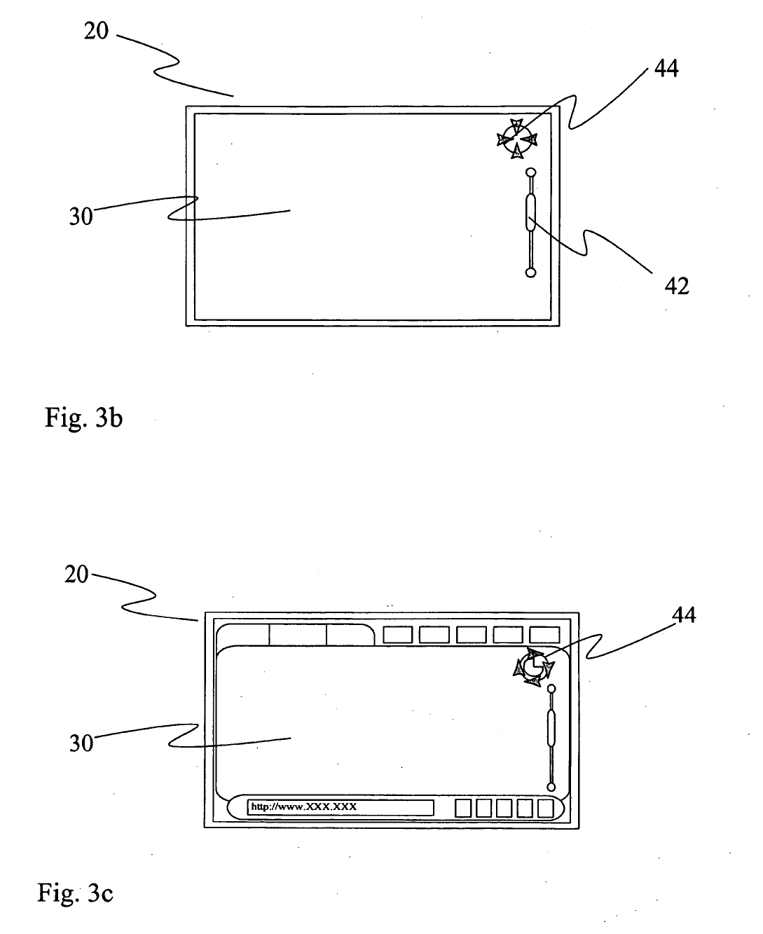

FIGS. 3a, 3b and 3c illustrate examples of the different display modes of the web browser on the display of an Internet terminal according to the invention.

FIG. 1 illustrates an example of the functional parts of a mobile Internet terminal 10 according to the invention by means of a block diagram. In this description a mobile terminal means a data processing device intended to be carried along by the user, with means for establishing a connection to the Internet 100 via a mobile communications network 200. The terminal has a memory 12 for loading and saving applications and files, and a processor 14 for executing the applications loaded into the memory of the terminal. Loaded into the memory there is at least an operating system 16 and a web browser 18, which can reproduce the content of the pages loaded from the Internet on the display 20 of the terminal. The terminal also has input means 22 for inputting information and commands. The input means can be, for example, a keyboard, a touch-screen display or some other suitable input means. The terminal device can also have many different data input means. In addition to the parts mentioned above, the terminal can also include other devices which are not needed for establishing an Internet connection but which increase the versatility of the terminal. Devices like this include a camera, a video camera, a receiver for radio and/or TV broadcasts, and means for sending and receiving telephone calls. Preferably the terminal is a mobile phone equipped with the Internet capabilities described above.

FIG. 2 illustrates an example of the Internet terminal 10 according to the invention as viewed from the side. The terminal has a cover 24, inside which the memory and processor shown in FIG. 1 are located. A display 20 and keys 26, which function as data input means, are located on the outer surface of the cover. The display in the terminal is a so-called touch-screen display, i.e. image areas that function like a key when touched can be produced on the display of the device. For using the touch-screen display, the equipment of the terminal include an elongated pointer 28, by which the user can use the touch-screen display. The touch-screen display and the pointer form the second information input means of the terminal. In addition, the Internet terminal according to the invention preferably includes at least means for sending and receiving telephone calls via a mobile cellular network. However, these properties do not fall within the scope of this invention, and they will not be discussed in more detail here.

FIGS. 3a, 3b and 3c illustrate the views on the display 20 of a terminal 10 according to the invention produced by a web browser operating in the operating system 16. FIG. 3a illustrates the display of the terminal in the so-called normal mode, which is called the first display mode in this description. In the centre of the display there is a content area 30, in which the content of the web pages downloaded from the Internet is reproduced. Above the content area on the top edge of the display there is the first task bar 32, which has a separate menu part 34 and a first icon part 36, which contains icons 40. Below the content area on the lower edge of the display there is a second task bar 33, which has an address space 38 for the Internet address of a web page open in the content area, and a second icon part 37. On one edge of the display inside the content area there is a scroll bar 42, which is used for scrolling the web page in the content area. The scroll bar operation is arranged in the web browser preferably so that it appears in the content area only when the web page cannot be shown in the content area in its entirety. Using menus, icons and scroll bars in a web browser is a well-known prior art technique, and therefore it is not explained in more detail here.

FIG. 3b shows the view of the display 20 of the Internet terminal when the browser is in the second display mode. In this display mode the task bars 32, 33 disappear from the display, and so essentially the whole area of the display is available for the content area 30. Due to the removal of the task bars, the size of the content area is clearly larger in the second display mode than in the first display mode.

In the Internet terminal according to the invention, switching from the first display mode to the second display mode is performed with an application program loaded into the memory of the terminal, which application program is integrated as part of the web browser of the terminal. The application program produces a graphical element 44 permanently placed in the content area, by which the switching from one display mode to another is carried out. The graphical element can be placed at any desired point in the content area. Preferably the graphical element is placed in the upper right corner of the content area, as shown in FIGS. 3a and 3b. The graphical element is advantageously such that it has a different shape in different display modes. Thus the shape of the display icon tells the user at once in which display mode the display of the terminal is. The graphical element can have any kind of appearance. The graphical element shown as an example in FIGS. 3a and 3b is formed of the periphery of a circle and triangular arrowheads placed at its quarter points. When the display is in the first display mode (FIG. 3a), the arrowheads of the graphical element 44 are pointed away from the centre of the circle. When the user of the terminal wants to switch the display to the second display mode, he simply touches the graphical element with the pointer, whereupon the application program switches the display to the second display mode (FIG. 3b). At the same time, the graphical element changes its shape so that the arrowheads are pointed towards the centre of the circle. When the user wants to switch from the second display mode back to the first display mode, he touches the graphical element again with the pointer, whereupon the display mode changes and the shape of the graphical element also changes.

FIG. 3c illustrates the view produced by the web browser on the display 20 of the terminal according to the invention when the content of the web page is being loaded into the memory of the terminal. When the pages are being loaded, the appearance of the graphical element 44 becomes such that it tells the user that the loading of the pages is in progress. The appearance of the graphical element preferably also indicates the stage of the loading operation. In a preferred embodiment of the invention illustrated by FIG. 3c, the arrowheads of the graphical element turn to follow the direction of the tangent of the periphery of the circle, when the loading of the pages in progress. At the same time, a segment of a circle appears in the centre of the graphical element, and its size indicates the stage of the loading process. The size of the segment increases with the progress of the page loading. In the case shown by FIG. 3c, the size of the segment is about ¾ of a full circle, i.e. about 75% of the content of the pages has been loaded. The page loading situation can also be expressed in some other suitable way in the graphical element. For example, the text loading together with a percentage indicating the stage of loading can appear in the graphical element. Instead of text and numbers, suitable figures and/or animations can be used in the switching window to indicate that the page loading is in progress. Preferably the size of the graphical element always remains the same, although its appearance is variable.

Thus the graphical element always covers essentially an equal part of the display of the terminal.

Some preferred embodiments of the terminal, application program and method according to the invention have been described above. The invention is not limited to the above described solutions only, but the inventive idea can be applied in many ways within the scope defined by the claims.

1. An Internet terminal with means for establishing a connection to the Internet via a mobile communications network, a processor, a display, information input means and a memory, into which at least an operating system and a web browser has been loaded, said web browser comprising means for switching the display to a first display mode or to a second display mode so that the size of the content area reserved for reproducing the web pages in the second display mode is essentially larger than in the first display mode, wherein said means for setting the display mode comprise a graphical element permanently placed in the content area, into which graphical element the display mode switching operation has been integrated in a way that selecting the graphical element causes the display mode to change.

2. An Internet terminal according to claim 1, wherein the content area and at least one task bar are visible on the display in the first display mode, and only the content area, which fills up essentially the whole display, is visible on the display in the second display mode.

3. An Internet terminal according to claim 1, wherein the graphical element is placed in the upper right corner of the content area.

4. An Internet terminal according to claim 1, wherein the graphical element is made to change its appearance so that it has a first appearance when the display is in the first display mode, and a second appearance when the display is in the second display mode, in which case the first and the second appearance are essentially different.

5. An Internet terminal according to claim 4, wherein the first appearance of the graphical element comprises a circle with arrowheads pointed away from the centre of the circle on its periphery, and the second appearance comprises a circle with arrowheads pointed towards the centre of the circle on its periphery.

6. An Internet terminal according to claim 1, wherein the graphical element also has a third appearance when the web pages are being loaded.

7. An Internet terminal according to claims 4, wherein the first, second and third appearance of the graphical element are essentially of equal size.

8. An Internet terminal according to claim 6, wherein the third appearance of the graphical element includes a verbal or pictorial indication that the web pages are being loaded.

9. An Internet terminal according to claim 6, wherein the third appearance of the graphical element includes a verbal or pictorial indication of the stage of the web page loading process.

10. An Internet terminal according to claim 1, wherein the display is a so-called touch-screen display.

11. A web browser in an Internet terminal with means for establishing a connection to the Internet via a mobile communications network, a processor, a display, information input means and a memory, into which at least an operating system has been loaded, the web browser comprising means for switching the display to a first display mode or to a second display mode so that the size of the content area reserved for reproducing the web pages in the second display mode is essentially larger than in the first display mode, wherein said means for setting the display comprise a graphical element permanently placed in the content area, into which graphical element the display mode switching operation has been integrated in a way that selecting the graphical element causes the display mode to change.

12. A web browser according to claim 11, wherein the content area and at least one task bar are visible on the display in the first display mode, and only the content area, which fills up essentially the whole display, is visible on the display in the second display mode.

13. A web browser according to claim 11, wherein the graphical element is placed in the upper right corner of the content area.

14. A web browser according to claim 11, wherein the graphical element is made to change its appearance so that it has a first appearance when the display is in the first display mode, and a second appearance when the display is in the second display mode, in which case the first and the second appearance are essentially different.

15. A web browser according to claim 14, wherein the first appearance of the graphical element comprises a circle with arrowheads pointed away from the centre of the circle on its periphery, and the second appearance comprises a circle with arrowheads pointed towards the centre of the circle on its periphery.

16. A web browser according to claim 11, wherein the graphical element also has a third appearance when the web pages are being loaded.

17. A web browser according to claims 14, wherein the first, second and third appearance of the graphical element are essentially of equal size.

18. A web browser according to claim 16, wherein the third appearance of the graphical element includes a verbal or pictorial indication that the web pages are being loaded.

19. A web browser according to claim 16, wherein the third appearance of the graphical element includes a verbal or pictorial indication of the stage of the web page loading process.

20. A method for setting a display mode of an Internet terminal with means for establishing a connection to the Internet via a mobile communications network, a processor, a display, information input means and a memory, into which at least an operating system and a web browser has been loaded, in which method the display is switched to a first display mode or to a second display mode so that in the second display mode the size of the content area reserved for reproducing the web pages is essentially larger than in the first display mode, wherein a permanent graphical element is produced on the content area of the display of the terminal, into which graphical element the display mode switching operation has been integrated in a way that selecting the graphical element causes the display mode to change.

21. A method according to claim 20, wherein the content area and at least one task bar are shown on the display in the first display mode, and only the content area, which fills up essentially the whole display, is shown on the display in the second display mode.

22. A method according to claim 20, wherein the graphical element is produced to the upper right corner of the content area.

23. A method according to claim 20, wherein the graphical element is made to change its appearance so that the graphical element has a first appearance when the display is in the first display mode, a second appearance when the display is in the second display mode, and a third appearance when the web pages are being loaded, in which case the first, the second and the third appearance are essentially different.

24. A web browser according to claim 23, wherein the first, second and third appearance of the graphical element are made essentially equal in size.

25. A method according to claim 23, wherein the third appearance of the graphical element indicates verbally or pictorially that the web pages are being loaded.

26. A method according to claim 23, wherein the third appearance of the graphical element indicates verbally or pictorially at which stage the web page loading process is.
